(19) United States
(12) Patent Application Publication
(10) Pub. No.: US 2008/0223190 A1
(43) Pub. Date: Sep. 18, 2008

(54) SHEET PUNCH DEVICE FOR PHOTO ATTACHMENT

(75) Inventor: Hyung-Dae BAE, Seoul (KR)

Correspondence Address: STEIN, MCEWEN & BUI, LLP, 1400 EYE STREET, NW, SUITE 300, WASHINGTON, DC, 20005, US

(73) Assignee: DN CRAFT CORPORATION, Seoul (KR)

(21) Appl. No.: 11/741,497

(22) Filed: Apr. 27, 2007

(30) Foreign Application Priority Data
Mar. 16, 2007 (KR) 10-2007-0025919

(51) Int. Cl. B26D 5/08

(52) U.S. Cl. 83/549

(57) ABSTRACT

A punch device of the invention comprises a jig having a corner punch area for punching a corner of the sheet material and an edge punch area for punching an edge of the sheet material, a corner punch block corresponding to the corner punch area, and an edge punch block corresponding to the edge punch area. Between the length L1 of the corner punch area, the width W1 of the corner punch area, the length L2 of the edge punch area and the width W2 of the edge punch area is established the relation of L1=W1=L2, W2≦½W1, and P=L1=L2.

### CROSS-REFERENCE TO RELATED APPLICATION

This application claims the benefit of Korean Application No. 2007-25919, filed Mar. 16, 2007, in the Korean Intellectual Property Office, the disclosure of which is incorporated herein by reference.

### BACKGROUND OF THE INVENTION

1. Field of the Invention

The present invention relates to a device for punching a sheet material such as papers, letters and cards, and more particularly to a punch device for punching a decoration pattern on edges of a sheet material where photos are attached.

2. Description of the Related Art

Generally, a punch device includes a jig in which a specific pattern hole is formed and a punch block having a sharp blade to pass through the pattern hole. The punch device performs punching a desired area in a sheet material with the pattern hole.

Such a punch device is widely used for punching an edge of a sheet material for decoration, to which a photo is to be attached. Conventionally, in doing so, a sheet material having a size lager than that of a photo to be attached may be provided, and then the corners and edges of the sheet material may be punched to a desired pattern by using a plurality of punch devices having different patterns.

Typically, photos are normalized in a size, while such a punch device is not normalized in terms of size. In this case, the sheet material should be sized according to the pattern of the punch device, not the photos. Otherwise, perforated pattern on the sheet material would not be consecutive, causing discontinuousness and/or dissymmetry of the perforated pattern. Further, the corners and edges of the sheet material should be punched by using a different kind of punch devices, respectively. Thus, there is a need for a punch device capable of punching corners and edges of a sheet material at the same time.

### SUMMARY OF THE INVENTION

An object of the invention is to provide a punch device, which enables to punch a specific pattern successively along a corner and an edge of a sheet material having a size proportional to the size of a photo to be attached thereto.

Another object of the invention is to provide a punch device capable of simultaneously punching a corner and an edge of a sheet material.

According to the invention, a decoration sheet to be attached with a rectangular photo can be punched at a constant interval on the corner and the edge thereof. Since the punch area of a punch device of the invention is a unit area, or equal to or less than a half unit area according to the size of a photo, a uniform and successive pattern can be formed symmetrically on the corner and edge of the sheet material to thereby eliminate an overlap or an interference of the pattern by the photo when being attached thereto.

In order to accomplish the above object, the present invention provides a punch device for punching a sheet material to which a rectangular photo is to be attached, the punch device comprising: a jig having a corner punch area, in which a first pattern hole is formed, for punching a corner of the sheet material, and a edge punch area, in which a second pattern hole is formed, for punching an edge of the sheet material, the corner punch area and the edge punch area being adjacent to each other in the proceeding direction D of the sheet material; a base on which the jig rests and having a supply surface for feeding the sheet material to the jig; a corner punch block having a punch pin corresponding to the first pattern hole so as to pass through the first pattern hole for punching the corner of the supplied sheet material; a edge punch block having a punch pin corresponding to the second pattern hole so as to pass through the second pattern hole for punching the edge of the supplied sheet material; a housing enclosing the jig and the punch blocks inside and having an opening at the upper portion; a corner pressing lever pressing down the corner punch block; and an edge pressing lever pressing down the edge punch block.

Preferably, the base may comprise a guide rail formed along the proceeding direction D of the sheet material to contact with a front end of a first edge of the sheet material for guiding the movement of the sheet material, and a plurality of stoppers contacting with a front end of a second edge perpendicular to the first edge of the sheet material to position the sheet material.

More preferably, the plurality of stoppers are spaced from each other at a constant pitch P. Also, when the front end of the second edge of the sheet material contacts with a first stopper, the corner of the sheet material lies on the corner punch area, and the edge of the sheet material lies on the portion of the edge punch area.

In the present invention, the corner punch area, the edge punch area and the pitch between the stoppers have relations of L1=W1=L2, W2≦½W1, and P=L1=L2. Here, L1 is the length of the corner punch area parallel to the proceeding direction D of the sheet material, W1 is the width of the corner punch area perpendicular to the proceeding direction D of the sheet material, L2 is the length of the edge punch area parallel to the proceeding direction D of the sheet material, and W2 is the width of the edge punch area perpendicular to the proceeding direction D of the sheet material.

Preferably, the each of L1, L2, W1 and P is a unit length A_{U}.

The sheet material may have a horizontal length L_{H(ST)} and a vertical length L_{V(ST)} wherein L_{H(ST)}=N1×L_{U} and L_{V(ST)}=N1×L_{U}. Here, N1 and N2 is an integer equal to or more than 3.

Also, the photo may have a horizontal length L_{H(PHT)} and a vertical length L_{V(PHT)} wherein L_{H(PHT)}=n1×L_{U} and L_{V(PHT)}=n2×L_{U}. Here, n1 and n2 is an integer equal to or more than 2. Further, the sheet material and the photo have relations of L_{H(ST)}=L_{H(PHT}+L_{U} and L_{V(ST)}=L_{V(PHT)}+L_{U}.

The invention may comprise an auxiliary base formed with the stoppers and detachably connected to the base. Preferably, a scale may be provided on at least one of the base or the auxiliary base.

The punch device of the invention may further comprise a corner pressing plate resting on the corner punch block and exposed through the opening of the housing; and an edge pressing plate resting on the edge punch block and exposed through the opening of the housing.

Also, the first pattern hole formed on the corner punch area may include an attachment slot into which an end of the corner of the photo is inserted.

### BRIEF DESCRIPTION OF THE DRAWINGS

These and other features, aspects, and advantages of the present invention will become better understood with regard to the following description, appended claims, and accompanying drawings, in which like components are referred to by like reference numerals. In the drawings:

FIG. 1 is a perspective view showing a punch device according to a preferred embodiment of the present invention;

FIG. 2 is a perspective view showing a punch device viewed from the back according to a preferred embodiment of the present invention;

FIG. 3 is an exploded perspective view showing a punch device according to a preferred embodiment of the present invention;

FIG. 4 schematically shows a corner punch area and an edge punch area in a punch device according to a preferred embodiment of the present invention;

FIG. 5 schematically shows a photo to be attached to a sheet material to be punched by using a punch device of the present invention;

FIG. 6 is a diagram schematically showing the comparison of a photo and a sheet material to be punched by a punch device of the present invention;

FIG. 7 is a perspective view showing the state in which a corner of a sheet material is punched by using a punch device of the preferred embodiment of the invention;

FIG. 8 is a schematic plan view of FIG. 7;

FIG. 9 is a schematic plan view of a sheet material where a corner and a unit edge are punched as a result of FIG. 7;

FIG. 10 is a schematic plan view showing the state in which a subsequent edge of a sheet material is punched by a punch device of the preferred embodiment of the invention;

FIG. 11 is a schematic diagram showing a sheet material of which corner and edge were punched by a punch device of the invention;

FIG. 12 is a schematic plan view where another corner and edge of a sheet material are punched by using a punch device of the preferred embodiment of the invention;

FIG. 13 is illustrating a punched sheet material to which a photo is attached according to the preferred embodiment of the invention.

### DETAILED DESCRIPTION OF THE PREFERRED EMBODIMENT

Hereinafter, preferred embodiments of the present invention will be described in detail with reference to the accompanying drawings.

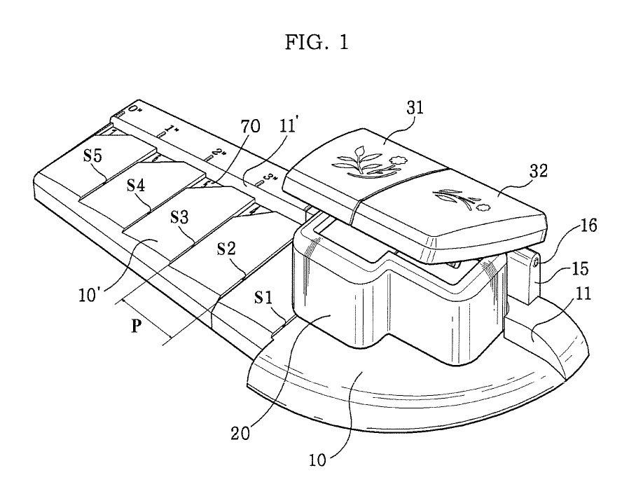

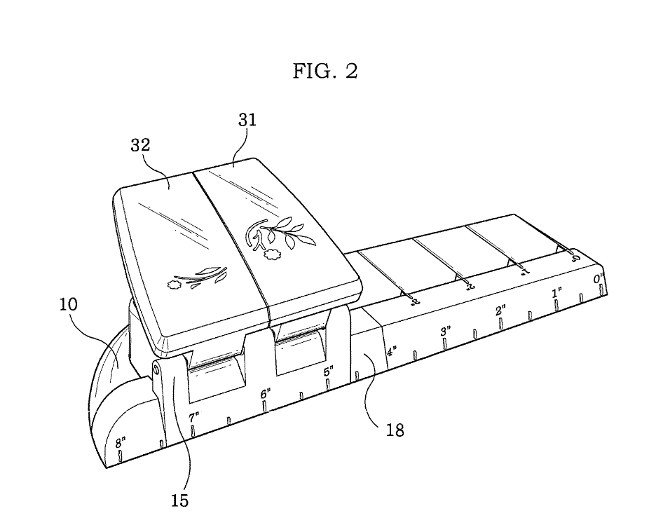

FIGS. 1 through 3 show a punch device for punching a sheet material to be attached with a photo according to a preferred embodiment of the present invention. The punch device of the invention performs punching corners and edges of a rectangular sheet material such as letters, papers and postcards (hereinafter referred as ‘a sheet material’).

Referring to the FIGS. 1 through 3, a punch device of the invention comprises a base 10 providing a supply surface on which a sheet material is supplied, a housing 20 containing a punch mechanism for punching the sheet material, and pressing levers 31 and 32 to be pressed by user's hands for punching the sheet material.

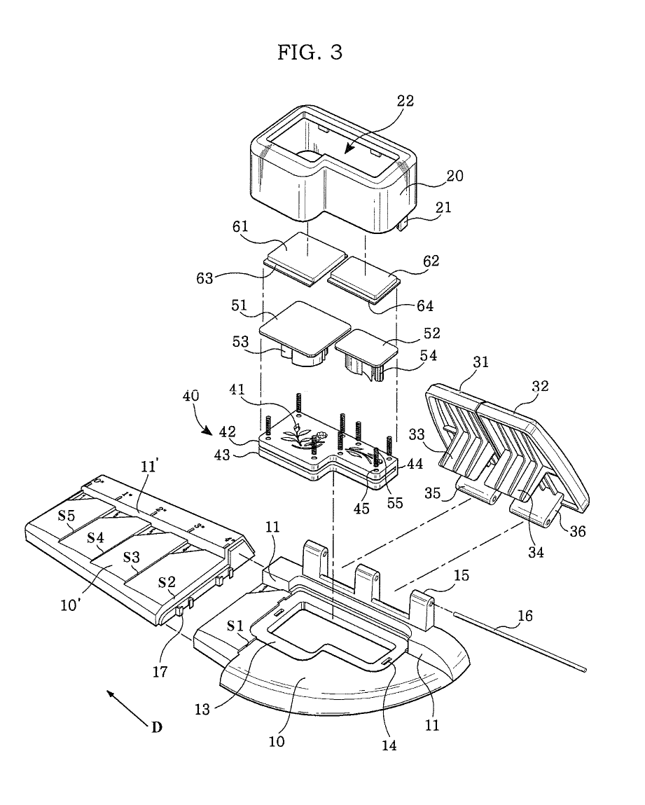

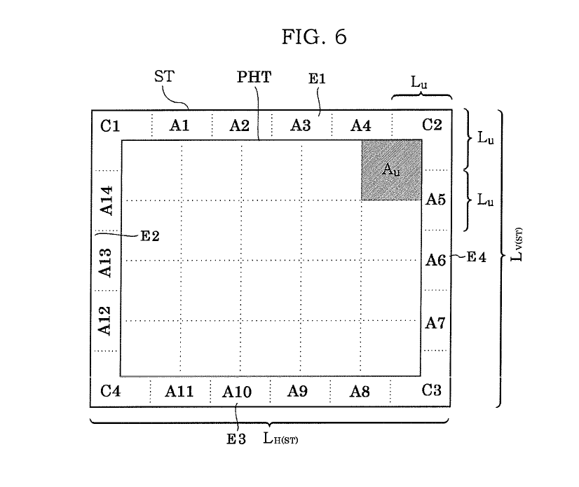

The punching mechanism is illustrated more in detail in FIG. 3. The base 10 is provided with a flat supply surface on which the sheet material is supplied, and a guide rail 11 parallel to the proceeding direction D of the sheet material to be punched for guiding the movement of the sheet material while contacting with a front end of a first edge (see E1 in FIG. 6) of the sheet material. Here, the first edge E1 of the sheet material means an edge at one side of the sheet material, which is parallel to the sheet proceeding direction D.

Also, a plurality of stoppers S1 to S5 are formed on the base 10, which contact a front end of a second edge (see E2 in FIG. 6) perpendicular to the first edge E1 of the sheet material to determine the punching position of the sheet material. Thus, the guide rail 11 guides the front end of the first edge E1 of the sheet material, while the front end of the second edge E2 of the sheet material abuts one of the stoppers S1 to S5 so that the sheet material is positioned to enable punching the corner of the sheet material.

Also, the punch device of the present invention comprises a jig 40 having a gap horizontally formed to be supplied with the sheet material and a pattern hole 41 vertically formed in a specific design, and a punch blocks 51 and 52 moving up and down passing through the pattern hole 41 to thereby punch the sheet material.

The jig 40 rests on a recess 13 formed on the upper surface of the base 10. The jig 40 comprises an upper stripper jig 42 and a lower base jig 43 facing each other with the gap formed between them. The stripper jig 42 and the base jig 43 are connected each other by a connecting portion 44.

The stripper jig 42 and the base jig 43 face an upper surface and a lower surface of the sheet material which is supplied between the stripper jig 42 and the base jig 43, respectively. The shape of the pattern holes 41 on the stripper jig 42 and the base jig 43 is identical to each other, so that the punch blocks 51 and 52 pass through the pattern holes 41 to thereby punch the sheet material.

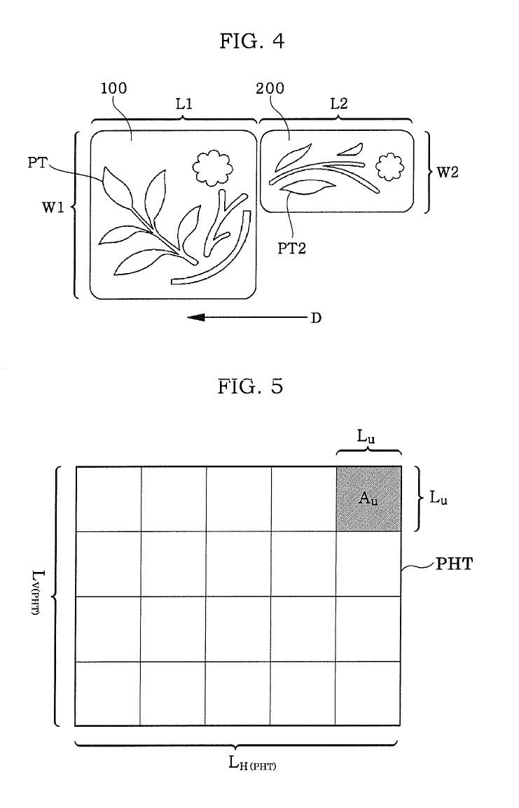

According to the present invention, as shown in FIG. 4, a corner punch area 100 and an edge punch area 200 are provided on the jig 40. The corner punch area 100 punches a corner of the sheet material in the predetermined pattern, having the hole 41 of a first pattern PT1. The edge punch area 200 punches a side edge of the sheet material in the predetermined pattern, having the hole 41 of a second pattern PT2. Though the first and second pattern PT1 and PT2 are shown to be discrete in figures, not limit to the embodiment, the first and second pattern PT1 and PT2 may be formed to be substantially continuous each other.

Hereinafter, ‘a punch area’ is defined as the area that is covered by each punching and the boundary where the pattern hole 41 can be formed. The pattern hole 41 may be formed in the punch area. Accordingly, a perforated pattern of the sheet material by the pattern hole 41 may be not coincident with the boundary of the punch area. The punch areas are divided separately so that they do not overlap each other when punching.

As shown in FIG. 4, the corner punch area 100 and the edge punch area 200 are adjacent each other along the proceeding direction D of the sheet material. Also, the corner punch area 100 is formed to be a square so that the length L1 of the corner punch area 100 parallel to the proceeding direction D of the sheet material is equal to the width W1 of the corner punch area 100 perpendicular to the proceeding direction D of the sheet material. On the contrary, the length L2 of the edge punch area 200 in the proceeding direction D is equal to the length L1 of the corner punch area 100, while the width W2 of the edge punch area 200 perpendicular to the proceeding direction D is equal to or less than a half width W1 of the corner punch area 100.

L1=W1=L2,

W2≦½W1. Equation 1

The configuration in which the width W2 of the edge punch area 200 is equal to or less than a half width W1 of the corner punch area 100 is for preventing a perforated pattern at edges of the sheet material from being covered by or being interfered with a normalized photo when it is attached to the sheet material as described later.

Preferably, the length L1 and L2, and width W1 is a unit length L_{U}.

L1=W1=L2=L_{U}. Equation 2

Though the jig 40 is integrally formed one piece, it is not limited, alternately the jig may be divided separately depending on the corner punch area and the edge punch area.

The punch block consists of a corner punch block 51 corresponding to the corner punch area 100 of the jig 40, and an edge punch block 52 corresponding to the edge punch area 200 of the jig 40.

A punch pin 53 having a pattern corresponding to the hole 41 of the first pattern PT1 is provided on the lower surface of the corner punch block 51 so as to pass through the first pattern hole 41 for punching the sheet material.

A plurality of elastic members such as a spring are interposed between the punch blocks 51 and 52 and the jig 40 in order to bias the punch blocks 51 and 52 upward. Preferably, the elastic members may rest on the grooves 45 formed on the upper surface of the jig 40.

The assembly of the jig 40 and the punch blocks 51 and 52 is contained in a housing 20. Preferably, the housing 20 is detachably connected to the base 10. Specifically, hook protrusions 21 formed at the lower end of the housing 20 is inserted into hook grooves 14 on the upper surface of the base 10 to thereby combine the housing 20 and the base 10 each other.

Preferably, pressing plates 61 and 62 are provided at the upper portion of the punch blocks 51 and 52. According to the present invention, the pressing plates consist of a corner pressing plate 61 located on the corner punch block 51, and an edge pressing plate 62 located on the edge punch block 52. The pressing plates 61 and 62 are exposed through an opening 22 of the housing 20. The pressing plates 61 and 62 are prevented from popping out by shoulders 63 and 64 of the pressing plates 61 and 62 contacting with the periphery of the opening 22. The pressing plates 61 and 62 are adopted to facilitate the smooth operation of the pressing levers 31 and 32 with respect to the punch blocks 51 and 52.

The pressing levers 31 and 32 are pivotally connected to the upper end of the housing 20 so that protrusions 33 and 34 formed on the lower surface of the pressing levers 31 and 32 press the upper surfaces of the pressing plates 61 and 62 which are exposed through the opening 22 of the housing 20. According to the invention, the pressing levers consist of a corner pressing lever 31 pressing the upper surface of the corner pressing plate 61, and an edge pressing lever 32 pressing the upper surface of the edge pressing plate 62.

Pivot brackets 35 and 36 of the pressing levers 31 and 32 are fixed to support protrusions 15 by a connecting rod 16, so that the pressing levers 31 and 32 are connected capable of rotating up and down, however not limited to the embodiment, alternately the pressing levers may be connected to the upper end of the housing 20.

Means for positioning the sheet material to be supplied is provided on the base 10 in order to punch the sheet material at a constant pitch. Specifically, a plurality of stoppers S1 through S5 are formed on the base 10 in the proceeding direction D of the sheet material, i.e., perpendicular to the guide rail 11. It should be understood that the stoppers may be replaced with markings or lines. The stoppers S1 to S5 are spaced from each other by a constant pitch (see P in FIG. 1). Accordingly, the second edge E2 of the sheet material to be punched subsequently abuts on one of the stoppers S1 to S5 to thereby stop at each time of punching the sheet material while the first edge E1 perpendicular to the second edge E2 slides along the guide rail 11 with contacting it, so that the sheet material can be positioned by a constant pitch for punching.

The number of the stoppers S1 to S5 may be appropriately selected depending on the size of a photo. Preferably, more stoppers S1 to S5 may be provided by adopting an auxiliary base 10′ which is detachable to the base 10 by means of joint members 17. On the auxiliary base 10′ provided a plurality of stoppers S2 to S5 at a constant pitch P. Also, the auxiliary base 10′ further comprises an auxiliary guide rail 11′ extending from the guide rail 11 of the base 10.

According to the present invention, the pitch P between the stoppers S1 to S5 is equal to the length L1 of the corner punch area 100 or the length L2 of the edge punch area 200.

P=L1=L2=L_{U}. Equation 3

Though the stoppers are illustrated as means for positioning the sheet material in the invention, not limited to the embodiment, they can be replaced with various modifications such as lines printed on the base.

Preferably, a scale or lines indicating the sequence of the stoppers may be printed on the surface of the base 10 and the auxiliary base 10′ for user's convenience. More preferably, the base 10 and the auxiliary base 10′ can be utilized for a scale or a cutting guide bar by providing a reference numeral on the other side 18 of the base 10 and the auxiliary base 10′.

FIG. 5 shows a diagram of a photo PHT to be attached to the sheet material punched by the present invention. According to the invention, a horizontal length L_{H(PHT)} and a vertical length L_{V(PHT)} of the photo is equal to n1 unit lengths L_{U} and n2 unit lengths L_{U}, respectively.

L_{H(PHT)}=n1×L_{U},

L_{V(PHT)}=n2×L_{U}. Equation 4

Here, n1 and n2 is an integer equal to or more than 2.

The photo PHT of FIG. 5 is shaped of a square having the horizontal length L_{H(PHT)}=5 L_{U} and the vertical length L_{V(PHT)}=4 L_{U}, consisting of twenty unit areas A_{U}. Here, the unit area A_{U} is defined as a square having a horizontal and a vertical length of a unit length L_{U}, respectively. Also, the unit length is a standard unit of length, preferably, 1 inch or 1 cm.

Meanwhile, a decoration sheet material ST for attaching the photo is illustrated in FIG. 6. According to the invention, the sheet material ST is a square consisting of N unit areas A_{U}, where the horizontal length L_{H(ST)} is equal to N1 unit lengths L_{U} and the vertical length L_{V(ST)} is equal to N2 unit lengths L_{U}.

L_{H(ST)}=N1×L_{U},

L_{V(ST)}=N1×L_{U}. Equation 5

Here, N1 and N2 is an integer equal to or more than 3.

Also, preferably, the horizontal length L_{H(ST)} and the vertical length L_{V(ST)} of the sheet material ST is longer than the horizontal length L_{H(PHT)} and the vertical length L_{V(PHT)} of the photo by a unit length L_{U}, respectively.

L_{H(ST)}=L_{H(PHT)}+L_{U},

L_{V(ST)}=L_{V(PHT)}+L_{U}. Equation 6

The punch device of the present invention can be used provided that the photo PHT and the sheet material ST have the above relation. For example, the sheet material ST of FIG. 6 comprises four corners C1 to C4 each having a unit area Au and fourteen unit edges A1 to A14 each having a unit area A_{U}. In FIG. 6, the reference numerals E1 to E4 denote a first edge to a fourth edge.

Now, a method of punching a rectangular sheet material using the punch device of the present invention is described.

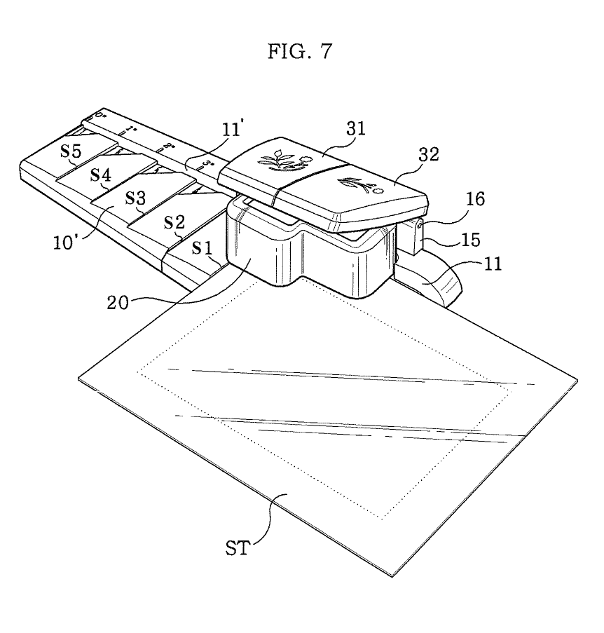

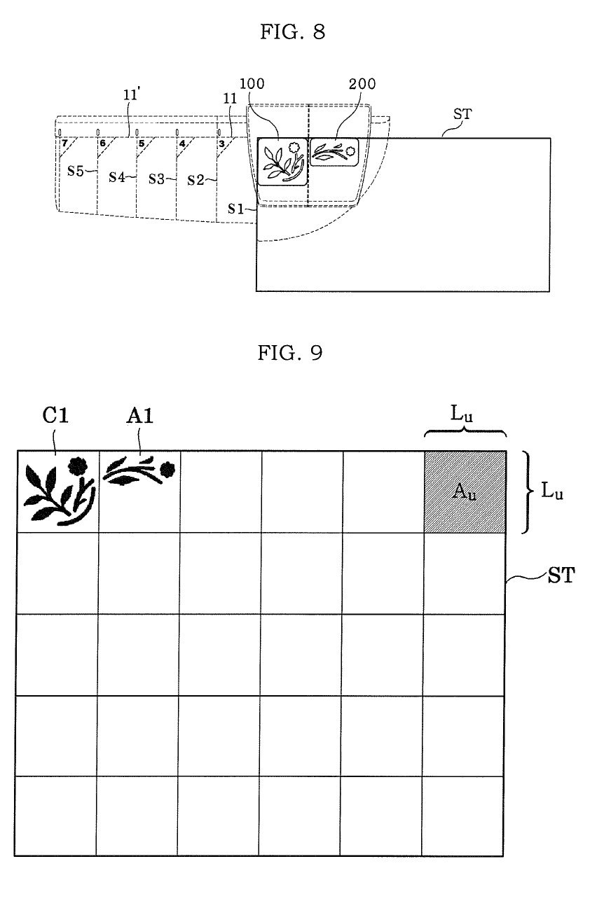

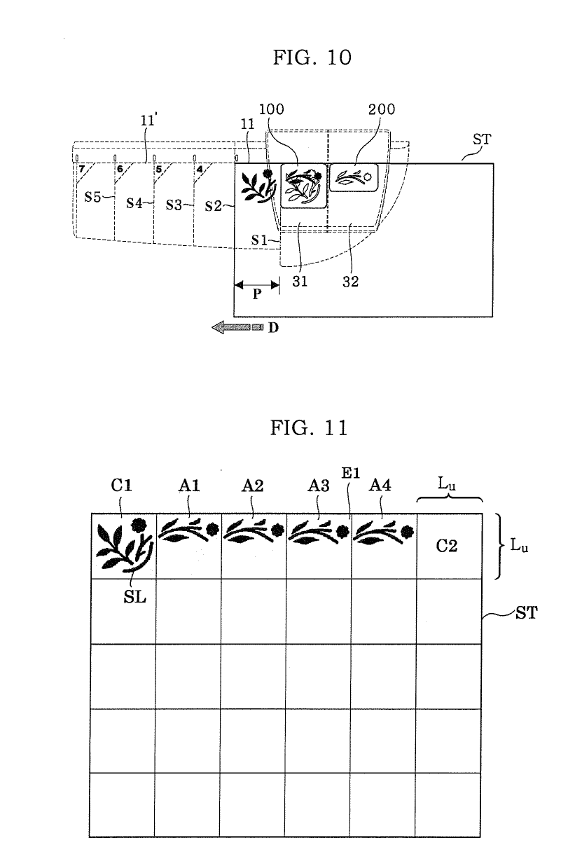

FIGS. 7 and 8 show a punch device in which a sheet material ST is supplied to be punched. In FIG. 8, punch areas and the pattern hole 41 are illustrated while other members are omitted for convenience of view.

Specifically, the sheet material ST is supplied on the supply surface of the base 10 to be inserted between the stripper jig 42 and the base jig 43 of the jig 40. Then, the front end of the first edge (see E1 in FIG. 6) of the sheet material ST contacts with the guide rail 11 of the base 10, and the front end of the second edge E2 of the sheet material contacts with the first stopper S1 to thereby position the sheet material ST. At this time, as shown in FIG. 8, the first corner (C1 in FIG. 6) of the sheet material ST lies on the corner punch area 100, while the first unit edge A1 lies on the edge punch area 200. That is, the first corner C1 of the sheet material coincides with the corner punch area 100 over a unit area. At the same time, the first unit edge A1 of the sheet material overlaps the edge punch area 200 by a half unit area.

In this state, a user presses the pressing levers 31 and 32. Then, the punch blocks 51 and 52 descend to punch the sheet material in the corner punch area 100 and the edge punch area 200, respectively. As a result, the first corner C1 and the first unit edge A1 are perforated with a first pattern PT1 and a second pattern PT2, respectively. Here, it should be noted that the corner C1 is punched over a unit area, while the unit edge A1 is punched over a half unit area.

After punching the first corner C1 and the first unit edge A1 of the sheet material, the sheet material ST is moved by a pitch P, i.e., a unit length, in the direction D in order to subsequently punch a second unit edge A2 of the sheet material ST, so that the front end of the second edge E2 abuts on a second stopper S2. In this state, the first unit edge A1 of the sheet material lies on the corner punch area, while the subsequent second unit edge A2 lies to overlap the edge punch area 200 by a half unit area. Then, only the edge pressing lever 32 is pressed down to thereby punch the second unit edge A2 of the sheet material ST with the second pattern PT2. Preferably, marking 70 is provided on the base 10 and the auxiliary base 10′ to help a user identify the sequence of punching.

After punching is performed, the sheet material ST is then moved by a pitch P, i.e., a unit length, in the direction D to position the front end of the second edge E2 to a third stopper S3. And then, the edge pressing lever 32 is pressed down to punch a third unit edge A3 with the second pattern PT2. The above operation is repeated until all the unit edges A1 to A4 of the first edge E1 are punched as shown in FIG. 11.

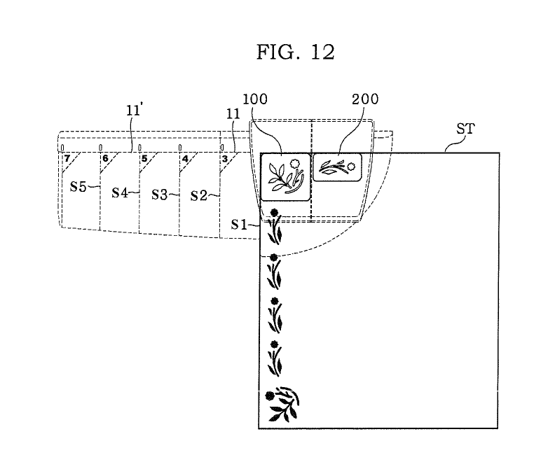

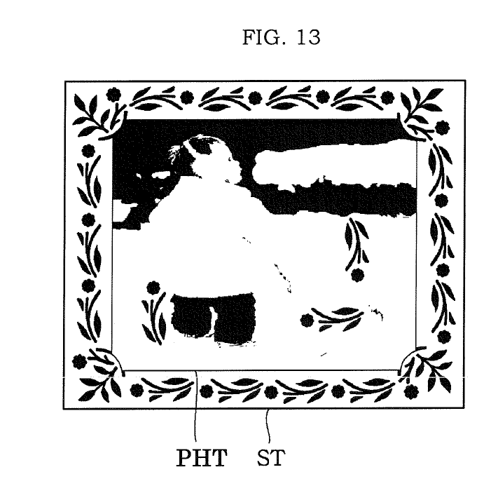

Subsequently, in order to punch a second corner C2 in FIG. 6 and a fourth edge E4 of the sheet material, as shown in FIG. 12, the sheet material is rotated counterclockwise at 90°. Here, the fourth edge E4 is perpendicular to the first edge E1 and parallel to the second edge E2.

In the above state, the second corner C2 of the sheet material ST lies on the corner punch area 100 over a unit area, while a fifth unit edge (see A5 in FIG. 6) overlaps the edge punch area by a half unit area. Accordingly, the second corner C2 and the fourth edge E4 can be perforated with the first pattern PT1 and the second pattern PT2, respectively, in the same way as mentioned above.

A third and a fourth corners (C3 and C4 in FIG. 6) and the third and the second edges E3 and E2 are completely punched in such a way to thereby obtain the sheet material having perforated patterns formed on all the edges thereof.

FIG. 14 shows a resultant sheet material ST to which a photo PHT is attached. The photo may be attached to the sheet material in various ways, which is not limited by the present embodiment. Preferably, the pattern formed on the corner may include an attachment slot (see SL in FIG. 11), into which ends of corners of the photo can be inserted for attachment.

According to the present invention, the corners C1 to C4 of the sheet material are punched over a unit area (unit length by unit length) by the corner punch area 100, and unit edges A1 to A4 are punched over a half unit area (unit length by ½ unit length). Accordingly, as shown in the Figure, when attaching the photo to the punched sheet material, the photo is prevented from covering or interfering with at least a portion of the patterns on the sheet material. Also, it is possible to obtain a uniform and symmetric pattern along the edges of the sheet material. Otherwise, if the width W2 of the edge punch area 200 is larger than a half unit area, the pattern on the sheet material would be screened by the photo.

According to the present invention, since the sheet material proceeds by a unit length, thereby punching the corners and the edges of the sheet material over a unit area each time, the pattern would be formed at a uniform and constant interval.

The corner and the edge punch areas of the present invention are normalized to a unit length, so that the size of the sheet material may be easily selected depending on the size of a photo. Also, the sheet material does not have to be sized according to the size of the photo.

Further, means for punching the corners and the edges of the sheet material are integrally adopted in the punch device of the invention, which eliminates the needs to take punch devices for the corners and the edges separately in the prior art.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A punch device for punching a sheet material to which a rectangular photo is to be attached, the punch device comprising:
a jig having a corner punch area, in which a first pattern hole is formed, for punching a corner of the sheet material, and an edge punch area, in which a second pattern hole is formed, for punching an edge of the sheet material, the corner punch area and the edge punch area being adjacent to each other along the proceeding direction D of the sheet material;
a base on which the jig rests and having a supply surface for feeding the sheet material to the jig;
a corner punch block having a punch pin corresponding to the first pattern hole so as to pass through the first pattern hole for punching the corner of the supplied sheet material;
an edge punch block having a punch pin corresponding to the second pattern hole so as to pass through the second pattern hole for punching the edge of the supplied sheet material;
a housing containing the jig and the punch blocks inside and having an opening at the upper portion;
a corner pressing lever pressing down the corner punch block; and
an edge pressing lever pressing down the edge punch block.

2. The punch device according to claim 1, wherein the base comprises:
a guide rail formed along the proceeding direction D of the sheet material to contact with a front end of a first edge of the sheet material for guiding the movement of the sheet material; and
a plurality of stoppers contacting with a front end of a second edge perpendicular to the first edge of the sheet material to position the sheet material.

3. The punch device according to claim 2, wherein the plurality of stoppers are spaced from each other at a constant pitch P, and
wherein when the front end of the second edge of the sheet material contacts with a first stopper, the corner of the sheet material lies on the corner punch area, while the edge of the sheet material lies on the portion of the edge punch area.

4. The punch device according to claim 3, wherein the corner punch area, the edge punch area and the pitch P between the stoppers have relations as follows,
L1=W1=L2,
W2≦½W1,
P=L1=L2,
in which L1 is the length of the corner punch area parallel to the proceeding direction D of the sheet material, W1 is the width of the corner punch area perpendicular to the proceeding direction D of the sheet material, L2 is the length of the edge punch area parallel to the proceeding direction D of the sheet material, and W2 is the width of the edge punch area perpendicular to the proceeding direction D of the sheet material.

5. The punch device according to claim 4, wherein the each of L1, L2, W1 and P is a unit length A_{U}.

6. The punch device according to claim 5, wherein the sheet material has a horizontal length L_{H(ST)} and a vertical length L_{V(ST)} as follows,
L_{H(ST)}N1×L_{U},
L_{V(ST)}=N1×L_{U},
in which N1 and N2 is an integer equal to or more than 3.

7. The punch device according to claim 6, wherein the photo has a horizontal length L_{H(PHT)} and a vertical length L_{V(PHT)} as follows,
L_{H(PHT)}=n1×L_{U}
L_{V(PHT)}=n2×L_{U}
in which n1 and n2 is an integer equal to or more than 2, and wherein the sheet material and the photo have relations as follows,
L_{H(ST)}=L_{H(PHT)}+L_{U},
L_{V(ST)}=L_{V(PHT)}+L_{U}.

8. The punch device according to claim 2, further comprising an auxiliary base formed with the stoppers and detachably connected to the base.

9. The punch device according to claim 8, wherein a scale is provided on at least one of the base or the auxiliary base.

10. The punch device according to claim 2, further comprising:
a corner pressing plate resting on the corner punch block and exposed through the opening of the housing; and
an edge pressing plate resting on the edge punch block and exposed through the opening of the housing.

11. The punch device according to claim 1, wherein the first pattern hole formed on the corner punch area includes an attachment slot into which an end of the corner of the photo is inserted.
